(19) United States
(12) Patent Application Publication
(10) Pub. No.: US 2024/0355525 A1
(43) Pub. Date: Oct. 24, 2024

(54) DUAL INDUCTOR ASSEMBLY

(71) Applicant: VISHAY DALE ELECTRONICS, LLC, Columbus, NE (US)

(72) Inventors: Benjamin HANSON, Yankton, SD (US); Steven HOFER, Yankton, SD (US)

(73) Assignee: VISHAY DALE ELECTRONICS, LLC, Columbus, NE (US)

(21) Appl. No.: 18/685,992

(22) PCT Filed: Aug. 24, 2021
(86) PCT No.: PCT/US2021/047309

§ 371 Date: Feb. 23, 2024

(51) Int. Cl. H01F 27/02; H01F 27/40

(52) U.S. Cl. CPC H01F 27/02; H01F 27/40

(57) ABSTRACT

A dual inductor assembly is provided that includes a holder in which first and second inductors have been inserted in order to provide a compact package as a single unit. The holder is designed to provide secure engagement of the inductors to improve shock and vibration performance. The configuration of the dual inductor assembly further allows for easier inspection of solder joints due to the housing configuration as well as the location of the leads on the inductor body.

### FIELD OF INVENTION

This application relates to the field of electronic components, particularly to electro-magnetic devices such as inductors, and more particularly to dual inductors arranged in a single package, used, for example, in audio amplifiers.

### BACKGROUND

Electromagnetic devices, such as inductors, are generally passive two-terminal electronic components. An inductor generally includes a conductor, such as a wire, wound into a coil. When current flows through the coil, energy is stored temporarily in a magnetic field in the coil. When the current flowing through an inductor changes, the time-varying magnetic field induces a voltage in the conductor, according to Faraday's law of electromagnetic induction.

Some known inductors have a core body of magnetic material, with a conductor positioned internally therein. The conductor can be formed as a wound coil. Examples of known inductors include U.S. Pat. No. 6,198,375 (“Inductor coil structure”) and U.S. Pat. No. 6,204,744 (“High current, low profile inductor”), the entire contents of which are incorporated by reference herein. Alternatively, the conductor can be a serpentine or otherwise shaped band or bar of conductive material.

A prior high current dual inductor was available from the present Applicant under the part number IHLD-3232HB-5A. This arrangement included two inductors arranged in an injection-molded holder to form one package with a shielded construction, in particular for audio amplifiers. This arrangement has proved successful in various applications. However, the press-fit of the inductors into the holder required a precise fit in the holder pockets and also resulted in residual stresses on the holder.

A further issue within the relevant industry relates to inspection of lead areas for solder connections.

It would be desirable to provide an improved dual inductor with easier assembly, potentially improved performance, and ease of inspection upon incorporation into a circuit assembly on a printed circuit board.

### SUMMARY

A dual inductor assembly including two or more inductors is disclosed herein that provides for easier assembly, as well as improved shock and vibration performance. Further, the configuration of the dual inductor assembly allows for easier inspection of solder joints due to the housing configuration as well as the location of the leads on the inductor body.

In one arrangement, the dual inductor assembly includes a holder including a top, first and second opposing sidewalls having respective first ends that are connected to the top, first and second opposing partial sidewalls having respective first ends connected to the top and respective first side edges connected to respective side edges of the first opposing sidewall, and third and fourth opposing partial sidewalls having respective first ends connected to the top and respective first side edges connected to respective side edges of the second opposing sidewall. The first and third partial sidewalls are aligned in a first plane and the second and fourth partial sidewalls are aligned in a second plane. This arrangement forms at least one pocket. Preferably, a central dividing wall is provided having a first end connected to the top, and first and second side edges connected respectively to the first and second opposing sidewalls to form first and second pockets.

Inner surfaces of the first and second opposing sidewalls, the first, the second, the third, and the fourth partial sidewalls, and the central dividing wall that face inwardly to define the first and second pockets may include spacer projections that are adapted to more closely match the side walls of the inductors to provide a closer fit. The spacer projections are preferably integrally formed with the holder.

For retaining the inductors in the holder, inwardly directed projections are located proximate to respective second ends of the first and second opposing partial sidewalls as well as the third and fourth opposing partial sidewalls.

First, second, third, and fourth openings are defined respectively in the first, the second, the third, and the fourth partial sidewalls. The first, second, third, and fourth openings extend toward the top from a position directly above each of the projections. These openings facilitate molding of the projections as well as provide for enhanced flexibility of the first, second, third, and fourth partial sidewalls for insertion of the inductors.

First and second inductors are inserted in the respective first and second pockets with a sliding fit, as defined below, not taking into account the protrusions being resiliently biased outwardly during insertion of the first and second inductors into the first and second pockets. The first inductor includes corresponding recesses in a side that faces the first and third partial sidewalls in which the inwardly directed projections on these partial sidewalls engage, and the second inductor includes corresponding recesses in a side that faces the second and fourth partial sidewalls in which the inwardly directed projections on these partial sidewalls engage in order to maintain the first and second inductors in the respective first and second pockets. It is also possible to use an adhesive for further securing the inductors in place.

In one arrangement, the first inductor includes leads that extend from a bottom of the first inductor to the side that faces the first and third partial sidewalls. These leads are at least partially visible in a first space between the first and third partial sidewalls in a plan view looking down at the top of the holder. Additionally, the second inductor includes leads that extend from a bottom of the second inductor to the side that faces the second and fourth partial sidewalls that are at least partially visible in a second space between the second and fourth partial sidewalls in a plan view looking down at the top of the holder. Preferably the inductor bodies do not have recesses for the leads and the leads extend on the respective sides of the first and second inductors in positions that are at least 50% unobstructed in a plan view looking down at the top of the holder to allow for easier visual inspection of solder joints when the dual inductor is installed on a PCB.

Preferably, the first and second inductors have a same physical size and same inductance values. However, the first and second inductors could be different. For example, the first and second inductors may have the same physical size, but have different inductances, or may have different physical sizes. In one embodiment, the projections include a taper at a side facing the second ends of the first, second, third, and fourth partial sidewalls. This facilitates assembly of the inductors in the pockets.

In one embodiment, the first and second opposing sidewalls include second ends opposite to the first ends, the first, second, third, and fourth partial sidewalls include second ends opposite to the first ends, and the second ends of the first and second opposing sidewalls and the second ends of the first, second, third, and fourth partial sidewalls are at a same level. Preferably, the level defines a pocket depth that exceeds 55% of a height of the first and second inductors.

In one embodiment, the holder is an injection molded polymeric part, and is preferably made of a polymeric material such as a liquid crystal polymer. The holder can alternatively be made of any other suitable material

In one embodiment, the first, second, third, and fourth openings extend to a bottom surface of the top. These openings allow for the insertion of part of the molding tool during injection molding of the holder in order to form the projections.

Preferably, the corresponding recesses on the respective sides of the first and second inductors are located at a medial position. These recesses may be formed such that they are shallower than the projections so that the holder applies some resilient pressure via the projections on the inductor bodies to maintain them in position.

Preferably the inductors are of a known type, and include a conductive element that is molded into a body. The conductive element has a specific shape, which can be for example, a serpentine or meandering shape, and may be formed having an “S” shape, or another shape having bent or curved areas, such as circular shape, an ellipsoid shape, or an Omega (Q) shape. Alternatively, the inductor can be a winding. The body of the inductor surrounds the conductive element, and may be pressed around the conductive element, leaving exposed terminal leads that extend from a surface or surfaces of the body. The conductive element is internally connected to a terminal lead on each end.

The body can be formed of a magnetic material including magnetic particles that are molded around the medial portion of the conductive element and portions of the first and second terminal leads. The magnetic particles can be a powdered or granular magnetic material, or more particularly, powdered iron particles.

### BRIEF DESCRIPTION OF THE DRAWING(S)

The foregoing aspects and many of the accompanying advantages of this invention will become more readily appreciated as the same becomes better understood by reference to the following detailed description when taken in conjunction with the accompanying drawings, wherein:

FIG. 1 is a perspective view of a dual inductor assembly according to an embodiment of the disclosure.

FIG. 2A is a right side view of the dual inductor assembly shown in FIG.1.

FIG. 2B is a left side view of the dual inductor assembly shown in FIG.1.

FIG. 3 is a top view of the dual inductor assembly shown in FIG.1.

FIG. 4A is a front view of the dual inductor assembly shown in FIG. 1.

FIG. 4B is a rear view of the dual inductor assembly shown in FIG. 1.

FIG. 5 is a perspective view, partially in crossed-section, of the dual inductor assembly shown in FIG. 1.

FIG. 6 is a cross-sectional view of the dual inductor assembly shown in FIG. 1.

FIG. 7 is a front view of the dual inductor assembly shown in FIG. 1 with the holder shown partially transparent.

FIG. 8 is a bottom view of the dual inductor assembly shown in FIG. 1.

FIG. 9 is a top, front, right perspective view showing the holder used for an embodiment of the dual inductor assembly.

FIG. 10 is a bottom, rear, left perspective view showing the holder of FIG. 9.

FIG. 11 is a front view of the holder shown in FIG. 9.

FIG. 12 is a top plan view of the holder shown in FIG. 9.

FIG. 13 is a bottom plan view of the holder shown in FIG. 9.

FIG. 14 is a partial perspective view looking up from the bottom into a portion of one of the pockets defined by the holder shown in FIG. 9.

FIG. 15 is a perspective view of one embodiment of an inductor used in the dual inductor assembly.

FIG. 16 is a front view of the inductor shown in FIG. 15.

FIG. 17 is a side view of the inductor shown in FIG. 15.

### DETAILED DESCRIPTION

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

For the purposes of the present application, the term “dual” in connection with the dual inductor assembly means “two or more”, and the dual inductor assembly therefore may include two or more inductors. The term “inductor” may be construed generally as any electro-magnetic, two terminal circuit component. A sliding fit means a fit with a tolerance of 0.002 to 0.020 inches (approximately 0.050 to 0.5 mm), not taking into account the resilient action of the projections in the holder that engage in recesses in the inductor body during the installation process. The terms approximately or generally mean within +/−10% of a specified value unless otherwise noted and within +/−5° of a specified angle or direction. The term “same” with respect to inductance values of inductors means within industry normal tolerances.

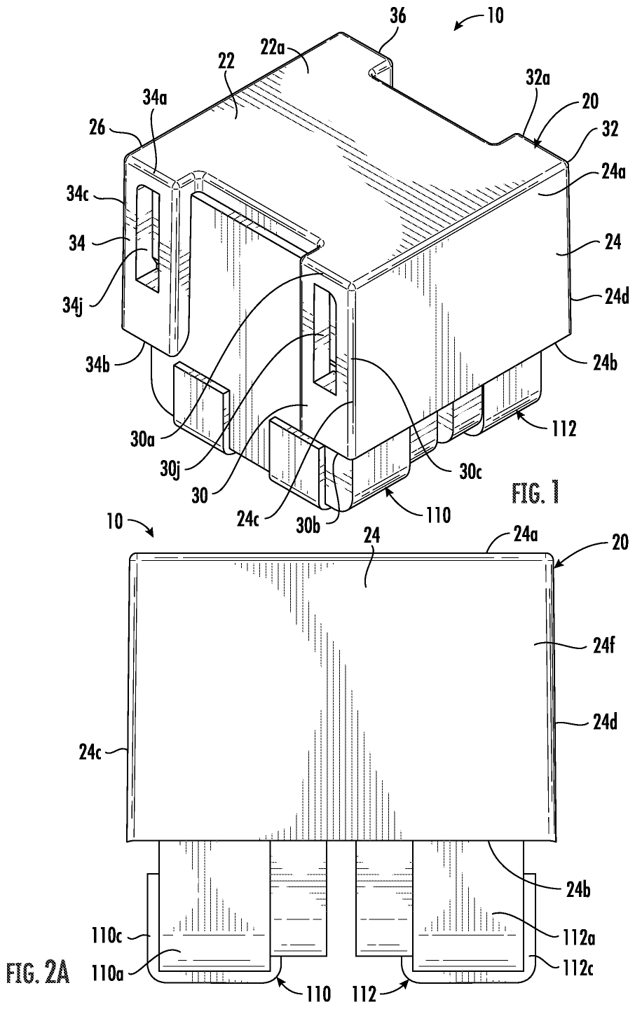

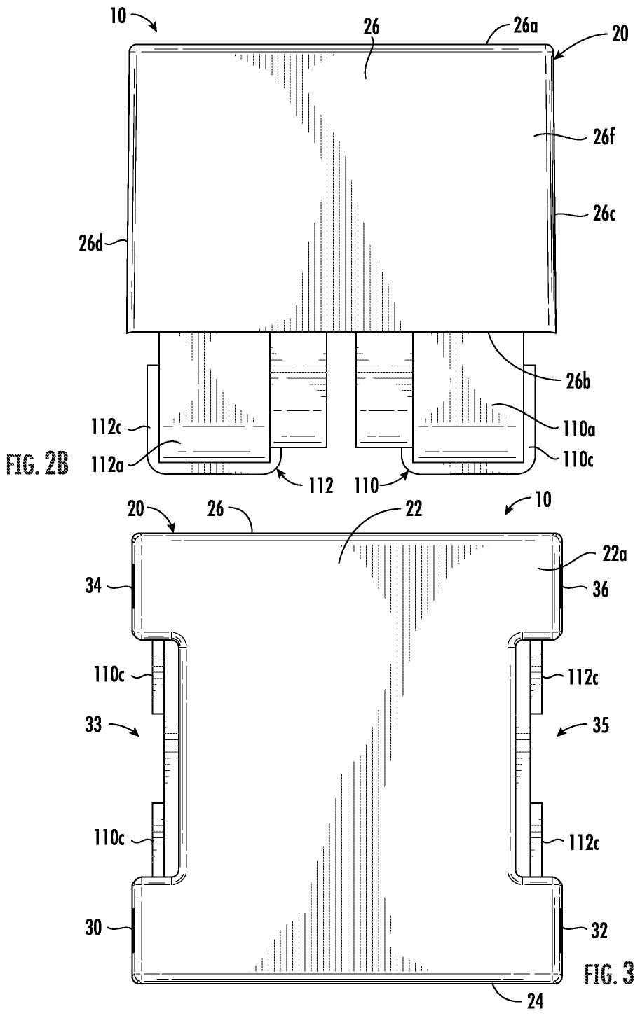

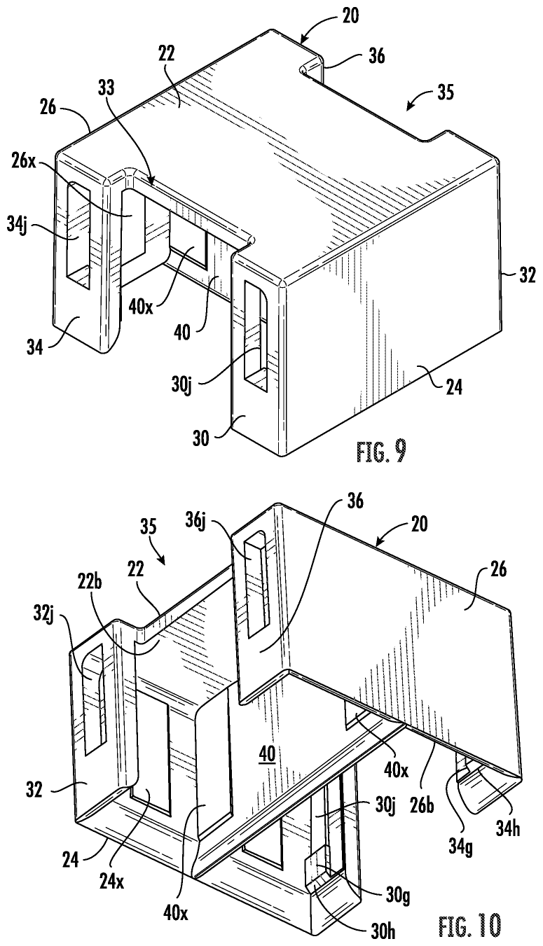

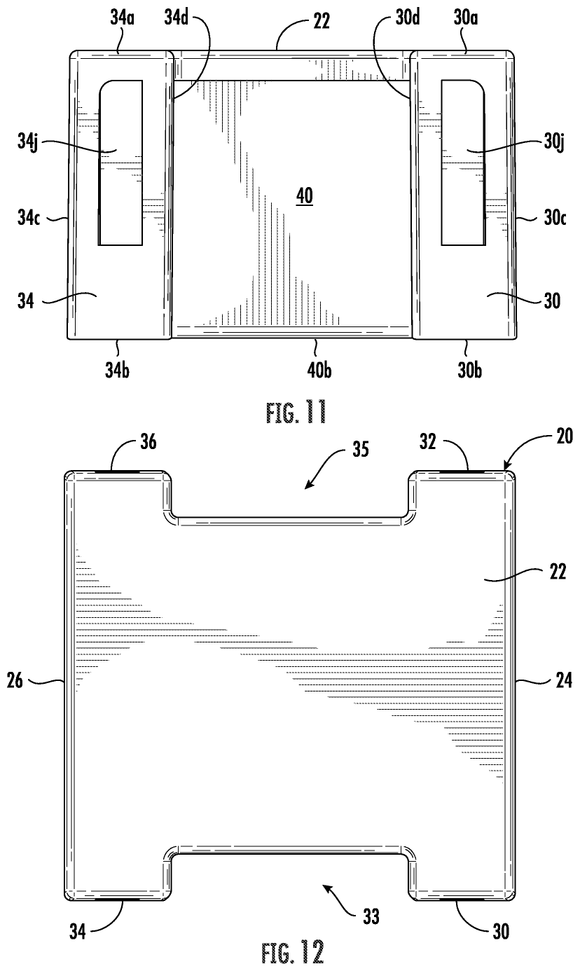

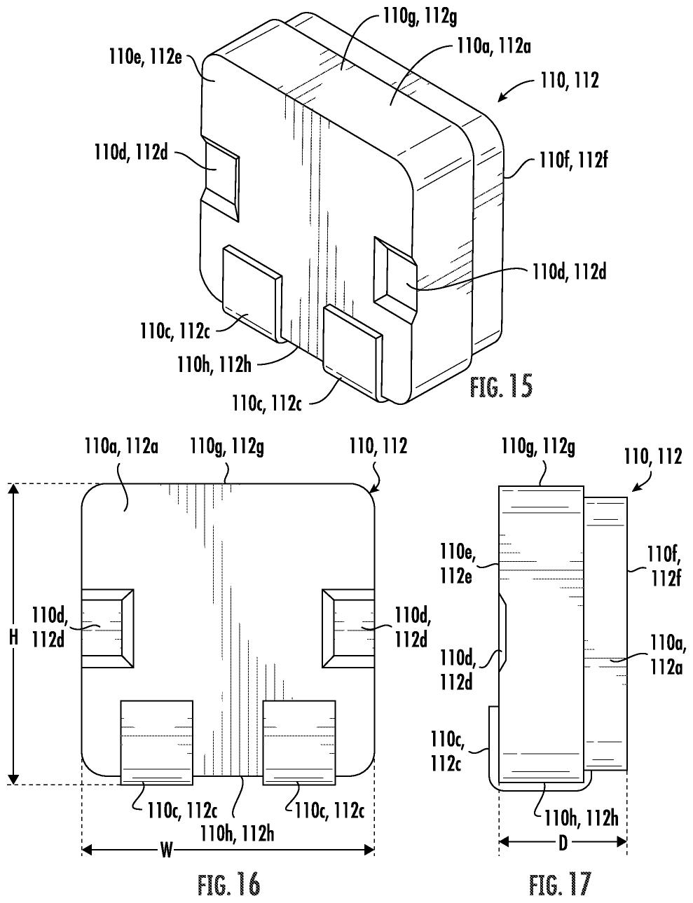

Referring to FIGS. 1-8, an embodiment of a dual inductor assembly 10 is shown. The dual inductor assembly 10 includes a holder 20 in which first and second inductors 110, 112 have been inserted in order to provide a compact package as a single unit. While first and second inductors are shown, it is envisioned that there could be three or more of the inductors and this is encompassed within the meaning of a “dual inductor assembly”. FIGS. 9-14 show detailed views of the holder 20 alone, and FIGS. 15-17 show views of a single inductor 110, 112 prior to being assembled into the dual inductor assembly 10. In the disclosed embodiment, the inductors 110, 112 are identical in size and function. However, it is within the scope of the present disclosure to allow for different sizes and/or properties. For example, the first and second inductors 110, 112 have the same physical size, but have different inductances.

As shown in FIGS. 1-5, 9, and 12, the holder 20 includes a top 22. The top 22 has an upper surface 22a and a lower surface 22b. First and second opposing sidewalls 24, 26 having respective first ends 24a, 26a are connected to the top 22. The first sidewall 24 further includes a second end 24b opposite the first end 24a, as well as first and second side edges 24c, 24d. It also includes an inside surface 24e and an outside surface 24f. The second sidewall similarly includes a second end 26b, first and second side edges 26c, 26d, as well as an inside surface 26e and an outside surface 26f.

Referring to FIGS. 1, 4A, 4B, 5, and 9-11, first and second opposing partial sidewalls 30, 32, are provided having respective first ends 30a, 32a that are connected to the top 22 and respective first side edges 30c, 32c that are connected to the respective first and second side edges 24c, 24d of the first opposing sidewall 24. Third and fourth opposing partial sidewalls 34, 36 are also provided having respective first ends 34a, 36a connected to the top 22 and respective first side edges 34c, 36c connected to respective first and second side edges 26c, 26d of the second opposing sidewall 26. Each of the partial sidewalls 30, 32, 34, 36 respectively include second ends 30b, 32b, 34, 36b, second side edges 30d, 32d, 34d, 36d, inside surfaces 30e, 32e, 34e, 36e, and outside surfaces 30f, 32f, 34f, and 36f. This arrangement defines at least one pocket that can accommodate the first and second inductors 110, 112.

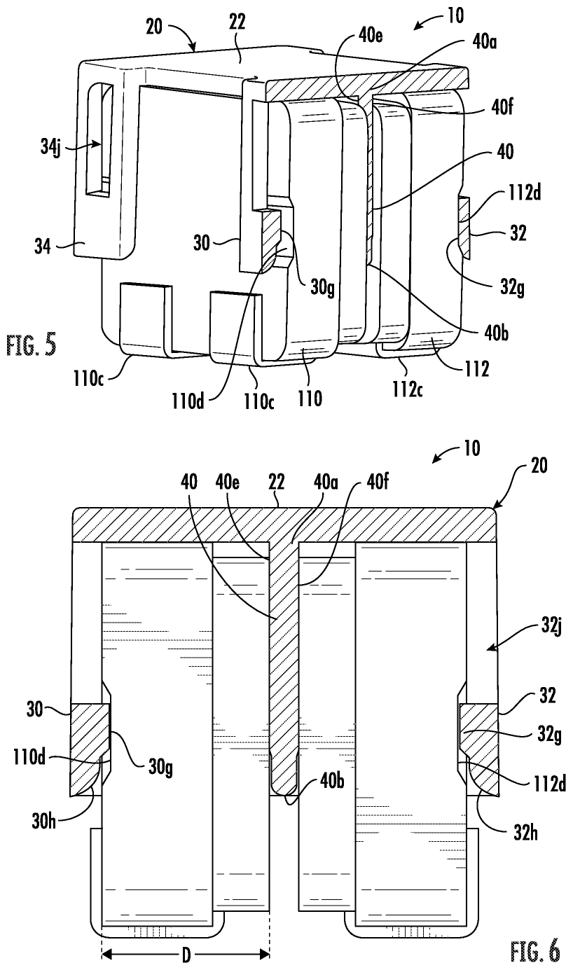

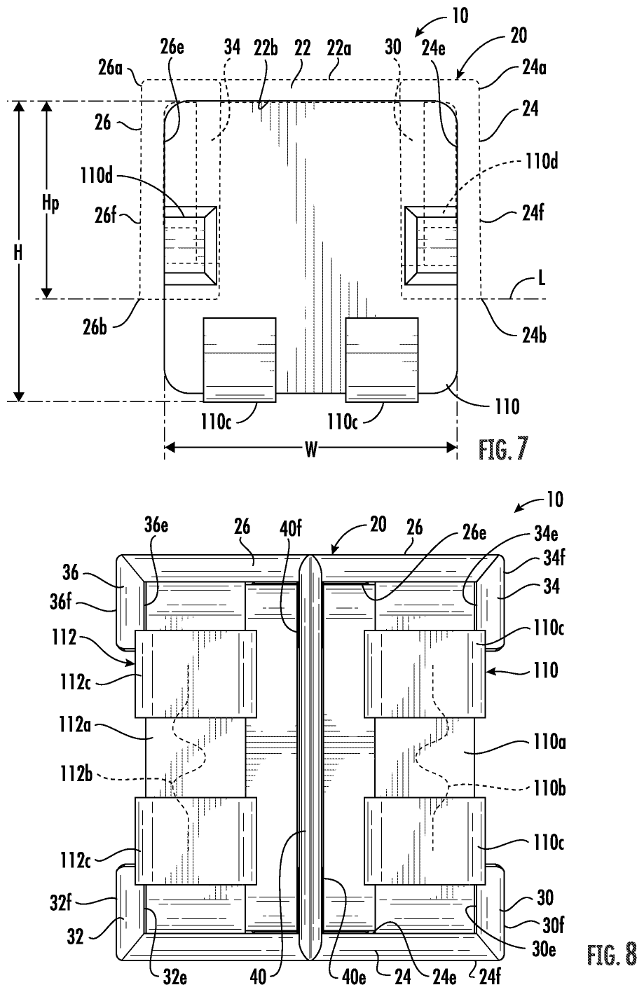

Preferably, a central dividing wall 40 is provided as shown in detail in FIGS. 5, 6, 8, 9-11, 13, 14 and includes a first end 40a connected to the top 22 as well as first and second side edges 40c, 40d connected respectively to the first and second opposing sidewalls 24, 26. As shown in detail in FIGS. 9, 10, 13, and 14, this structure forms first and second pockets 42, 44 in the holder 20. The central dividing wall 40 further includes a second end 40b shown most clearly in FIGS. 8, 10, and 13, as well as first and second surfaces 40e, 40f.

Referring to FIGS. 5, 6, and 14, inwardly directed projections 30g, 32g, 34g, 36g are located proximate to respective second ends 30b, 32b, 34b, 36b of the first and second opposing partial sidewalls 30, 32 and the third and fourth opposing partial sidewalls 34, 36. These projections 30g, 32g, 34g, 36g preferably include a taper 30h, 32h, 34h, 36h toward the second ends 30b, 32b, 34b, 36b of the partial sidewalls 30, 32, 34, 36. FIG. 14 shows a detailed view of the projection 34b, and the other projections 30g, 32g, and 36g are mirror-symmetric to the projection 34g shown.

Additionally, as shown in detail in FIGS. 1, 4A, 4B, 5, 9-11, and 14, first, second, third, and fourth openings 30j, 32j, 34j, 36j are defined respectively in the first, second, third, and fourth partial sidewalls 30, 32, 34, 36. These openings 30j, 32j, 34j, 36j extend toward the top 22 from a position directly above each of the projections 30g, 32g, 34g, 36g. These openings 30j, 32j, 34j, 36j have two functions. First, in order to allow molding of the projections 30g, 32g, 34g, 36g, pins that are part of the injection mold extend in the area of the openings 30j, 32j, 34j, 36j and into the area of the first and second pockets 42, 44 where they contact the pocket forming mold parts. Once the material forming the holder 20 is injected, the pins are withdrawn leaving the openings 30j, 32j, 34j, 36j. This allows the projections 30g, 32g, 34g, 36g to be formed that extend into the pockets 42, 44 without trapping the holder 20 on the tool. The second function of the openings 30j, 32j, 34j, 36j is to impart additional flexibility to the first, second, third, and fourth partial sidewalls 30, 32, 34, 36. This allows the partial sidewalls 30, 32, 34, 36 to resiliently deflect outwardly as the first and second inductors 110, 112 are inserted, as described in further detail below. Further, these openings 30j, 32j, 34j, 36j preferably extend to a bottom surface 22b of the top 22.

The holder 20 is preferably an injection molded polymeric part, and more preferably is formed of a liquid crystal polymer that can withstand high temperatures, for example, up to 155 degrees C.

As shown in FIGS. 9, 10, 13, and 14, the inner surfaces 24e, 26e of the first and second opposing sidewalls 24, 26, the inner surfaces 30e, 32e, 34e, 36e of the first, second, third, and fourth partial sidewalls 30, 32, 34, 36, as well as the first and second surfaces 40e, 40f of the central dividing wall 40 may include spacer projections 24x, 26x, 40x that are adapted to more closely match the dimensions of the inductors 110, 112 in order to provide a close fit, as described in more detail below.

Preferably, the second ends 24b, 26b of the sidewalls 24, 26 as well as the second ends 30b, 32b, 34b, 36b of the first, second, third, and fourth partial sidewalls 30, 32, 34, 36 are all located at a same level, indicated as L in FIG. 7. These ends may further include a taper, shown in FIGS. 10. 13, and 14, to facilitate insertion of the first and second inductors 110, 112.

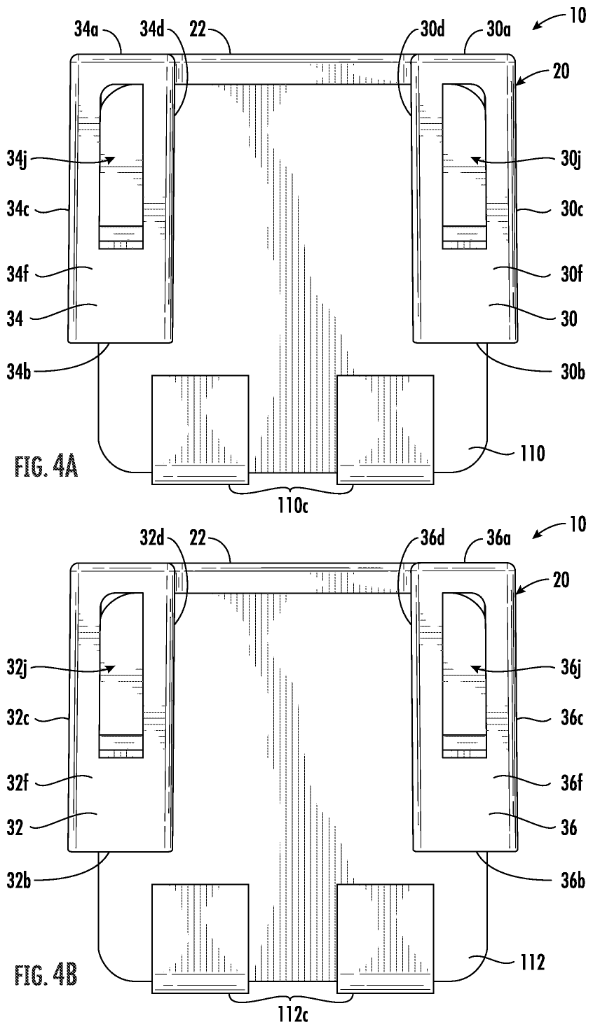

Referring to FIGS. 1, 4A, 4B 5-8, and 15-17, first and second inductors 110, 112 are inserted in the respective first and second pockets 42, 44 with a sliding fit. This sliding fit refers to final installation position of the inductors 110, 112 in the respective first and second pockets 42, 44. The inductors 110, 112 each include a body 110a, 112a, as well as a conductive element 110b, 112b (see FIG. 8) located within the body 110a, 112a. The first and second inductors 110, 112 both include corresponding recesses 110d, 112d located on the first side 110e that faces the first and third partial sidewalls 30, 34, for the first inductor 110 and the first side 112e which faces the second and fourth partial sidewalls 32, 36 for the second inductor 112. The inwardly directed projections 30g, 34g of the first and third partial sidewalls 30, 34 therefore engage into the corresponding recesses 110d in the first side 110e of the first inductor 110 while the projections 32g, 36g of the second and fourth partial sidewalls 32, 36 engage in the recesses 112d in the first side 112e of the second inductor 112 in the installed position. This engagement maintains the first and second inductors 110, 112 in their respective first and second pockets 42, 44. It is also possible to apply an adhesive to one or more of the interfacing surfaces between the first and second inductors 110, 112 and the holder 20 to more securely hold the inductors 110, 112 in position.

As shown in FIGS. 15-17, each of the inductors 110, 112 includes leads 110c, 112c that extend from the respective bottom 110h, 112h to the respective first side 110e, 112e that faces respectively, the first and third partial sidewalls 30, 34 for the first inductor 110 and the second and fourth partial sidewalls 32, 36 for the second inductor 112. The inductors 110, 112 further include second sides 110f, 112f that face the central dividing wall 40, as well as tops 110g, 112g that are inserted first into the pockets 42, 44.

The inductor body 110a, 112a is preferably formed of a magnetic material that is molded about the conductive element 110b, 112b. In an embodiment, the inductor body 110a, 112a may be formed of a ferrous material. In an embodiment, the inductor body 110a, 112a may comprise, for example, iron, metal alloys, ferrite, combinations of the foregoing, or other materials known in the art of inductors and used to form such bodies. In an embodiment, the inductor body 110a, 112a may be formed from magnetic particles such as powdered or granular magnetic particles. In an embodiment, the magnetic particles can be powdered iron particles. In a non-limiting example, a magnetic material may be used for the inductor body comprised of a powdered iron particles, a filler, a resin, and a lubricant, such as described in U.S. Pat. No. 6,198,375 (“Inductor Coil Structure”) and U.S. Pat. No. 6,204,744 (“High Current, Low Profile Inductor”), both of which are incorporated by reference as if fully set forth herein.

Non-limiting examples of a package-shape for the inductor body 110a, 112a include a box-shape, a cuboid shape, a rectangular prism, any of the foregoing including rounded corners (see FIGS. 15-17), one or more irregular surface, etc. One of ordinary skill in the art will recognize that other inductors shapes can be employed without departing from the spirit of the invention

Acceptable metals used for forming the conductive element 110b, 112b may be copper, aluminum, platinum, or other metals for use as inductor coils as are known in the art. In an exemplary embodiment the conductive element may be made into a preformed member by bending the conductive material into a selected shape. Non-limiting examples of wires that can be used to form the conductive element 110b, 112b include a flat wire, square wire, or rectangular shaped wire, round wire. One of skill in the art will recognize that other wire shapes could be used within the scope of this invention. The length, width, and height of the conductive element 110b, 112b and inductor body 110a, 112a may vary based on the inductor application. Additionally, the properties of the conductive element 110b, 112b could vary to provide different inductances for the first and second inductors 110, 112 having bodies 110a, 112a with the same physical size. The dimensions of the conductive element 110b, 112b may be designed to increase the ratio of the space used compared to the space available in the inductor body 110a, 112a.

A first space 33 is located between the first and third partial sidewalls 30, 34, and the terminal leads 110c of the first inductor 110 are at least partially visible in a plan view looking down at the top 22 of the holder 20, as shown in FIG. 3. Similarly, a second space 35 is located between the second and fourth partial sidewalls 32, 36, and the second terminal leads 112c are at least partially visible in the second space 35 in a plan view looking down at the top 22 of the holder 20, also shown in FIG. 3. Here, at least partially visible means that at least 50% of the terminal leads 110c, 112c are visible in a plan view looking down at the top 22 of the holder 20. This allows for easier inspection once the dual inductor assembly 10 is installed on a PCB or other electronic component to determine if the solder joints have been made.

In the preferred embodiment, the first and second inductors 110, 112 have a same physical size and the same inductance values. However, this can be varied depending upon the particular application.

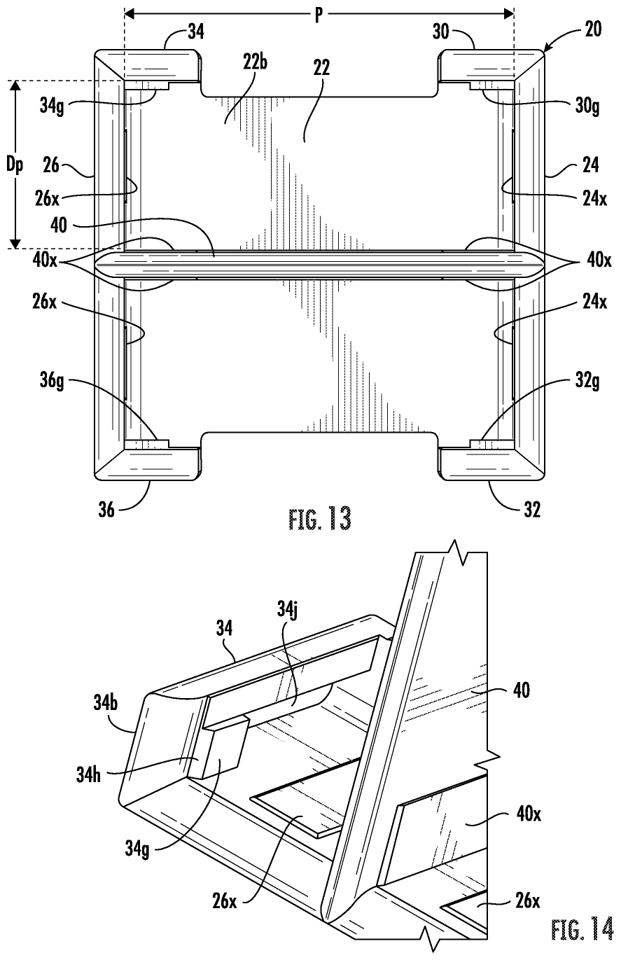

Referring to FIG. 7, the level L defined by the second ends 24b, 26b, 30b, 32b, 34b, and 36b of the sidewalls and partial sidewalls defines a pocket depth H_{P} that exceeds 55% of a height H of the first and second inductors 110, 112. Additionally, with reference to FIGS. 13, 16, and 17, the width W of the finished inductor in one embodiment is about 7 mm while the depth D is about 2.3 mm (see FIGS. 16 and 17). Not taking into account the area occupied by the projections 30g, 34g, 36g, the insertion area of each of the pockets has a receiving Width P as well as a receiving thickness D_{P} of approximately 7.1 mm and 2.4 mm respectively (indicated in FIG. 13). The height of the projections 30g, 32g, 34g, 36g above the inner surfaces of the respective first, second, third, and fourth partial sidewalls 30, 32, 34, 36 is at least about 0.3 mm. The depth of the corresponding recesses 110d, 112d in the first and second inductors 110, 112 is also about 0.3 mm. However, these dimensions can be altered based on the particular assembly. Further, it is possible to provide a slight interference between the projections 30g, 32g, 34g, 36g and the corresponding recesses 110d, 112d of approximately 0.05-0.2 mm.

In the preferred arrangement, the corresponding recesses 110d, 112d are located at a medial position on the respective sides 110e, 112e of the first and second inductors 110, 112. However, the position can be varied for the particular application and holder 20 configuration

It will be appreciated that the foregoing is presented by way of illustration only and not by way of any limitation. It is contemplated that various alternatives and modifications may be made to the described embodiments without departing from the spirit and scope of the invention. Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

1. A dual inductor assembly, comprising:
a holder including a top, first and second opposing sidewalls having respective first ends connected to the top, first and second opposing partial sidewalls having respective first ends connected to the top and respective first side edges connected to respective side edges of the first opposing sidewall, and third and fourth opposing partial sidewalls having respective first ends connected to the top and respective first side edges connected to respective side edges of the second opposing sidewall, the first and third partial sidewalls being aligned in a first plane and the second and fourth partial sidewalls being aligned in a second plane, to define at least one pocket;
inwardly directed projections located proximate to respective second ends of the first and second opposing partial sidewalls and the third and fourth opposing partial sidewalls;
first, second, third, and fourth openings defined respectively in the first, the second, the third, and the fourth partial sidewalls, the first, second, third, and fourth openings extend toward the top from a position directly above each of the projections; and
first and second inductors inserted in the at least one pocket, the first inductor including corresponding recesses in a side that faces the first and third partial sidewalls in which the inwardly directed projections engage and the second inductor including corresponding recesses in a side that faces the second and fourth partial sidewalls in which the inwardly directed projections engage in order to maintain the first and second inductors in the respective first and second pockets.

2. The dual inductor assembly of claim 1, further comprising a central dividing wall having a first end connected to the top, and first and second side edges connected respectively to the first and second opposing sidewalls such that the at least one pocket includes first and second pockets, and the first and second inductors are inserted in the respective first and second pockets with a sliding fit.

3. The dual inductor assembly of claim 1, wherein the first inductor includes leads that extend from a bottom to the side that faces the first and third partial sidewalls that are at least partially visible in a first space between the first and third partial sidewalls in a plan view looking down at the top of the holder, and the second inductor includes leads that extend from a bottom to the side that faces the second and fourth partial sidewalls that are at least partially visible in a second space between the second and fourth partial sidewalls in a plan view looking down at the top of the holder.

4. The dual inductor assembly of claim 1, wherein the first and second inductors have a same inductance value.

5. The dual inductor assembly of claim 1, wherein the first and second inductors have a same physical size, but have different inductances.

6. The dual inductor assembly of claim 1, wherein the projections include a taper at a side facing the second ends of the first, second, third, and fourth partial sidewalls.

7. The dual inductor assembly of claim 1, wherein the first and second opposing sidewalls include second ends opposite to the first ends, the first, second, third, and fourth partial sidewalls include second ends opposite to the first ends, and the second ends of the first and second opposing sidewalls and the second ends of the first, second, third, and fourth partial sidewalls are at a same level.

8. The dual inductor assembly of claim 7, wherein the level defines a pocket depth that exceeds 55% of a height of the first and second inductors.

9. The dual inductor assembly of claim 1, wherein the holder is an injection molded polymeric part.

10. The dual inductor assembly of claim 1, wherein the first, the second, the third, and the fourth openings extend to a bottom surface of the top.

11. The dual inductor of claim 1, wherein the corresponding recesses are located at a medial position on the respective sides of the first and second inductors.

12. The dual inductor assembly of claim 1, further comprising an adhesive to hold the first and second inductors in the holder.

13. The dual inductor assembly of claim 1, further comprising an additional inductor located in the at least one pocket.
